(19) United States
(12) Patent Application Publication
(10) Pub. No.: US 2006/0160589 A1
(43) Pub. Date: Jul. 20, 2006

(54) Gaming machine and game system

(75) Inventor: Kazuo Okada, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Koto-ku (JP)

(21) Appl. No.: 11/302,089

(22) Filed: Dec. 14, 2005

(30) Foreign Application Priority Data
Dec. 28, 2004 (JP) 2004-381972

(51) Int. Cl. A63F 13/00

(52) U.S. Cl. 463/1

(57) ABSTRACT

A gaming machine has a storage unit, a reading unit, a first selecting unit, and a first providing unit. The storage unit stores game related data items. The reading unit reads out, from a recording medium held by a player, first selection information for selecting a first game related data item from the game related data items. The first selecting unit selects, based on the first selection information read out by the reading unit, the first game related data item from the game related data items stored in the storage unit. The first providing unit provides the player with game related information corresponding to the first game related data item selected by the first selection unit.

### CROSS REFERENCE TO RELATED APPLICATION

This application is based upon and claims the benefit of priority from the prior Japanese Patent Applications No. 2004-381972, filed on Dec. 28, 2004, the entire contents of which are incorporated herein by reference.

### BACKGROUND OF THE INVENTION

1. Field of the Invention

The present invention relates to a gaming machine such as a slot machine, a pachi-slot machine, a pachinko machine, etc., and also relates to a game system including a gaming machine and a sever that is connected in communication with the gaming machine.

2. Description of Related Art

A gaming machine is known which has a function of providing a player with game related information such as a method for operating the machine, game procedures, etc. In such a gaming machine, according to a technique disclosed, game related information provided to players is not uniform but varied so as to be suitable for a specific skill level in a game of each player (see Japanese Patent Unexamined Publication No. 2004-643). This technique can remove a problem of lack of information, etc., and can provide game related information suitable for each player.

### SUMMARY OF THE INVENTION

The above-described technique requires a player to input his/her own skill level. In addition, a player must have correct knowledge about his/her own skill level. If he/she does not have the correct knowledge, improper information is provided to him/her.

An object of the present invention is to provide a gaming machine and a game system capable of easily and surely providing an individual player with game related information which is suitable for the player.

According to a first aspect of the present invention, there is provided a gaming machine having a storage unit, a reading unit, a first selecting unit, and a first providing unit. The storage unit stores game related data items. The reading unit reads out, from a recording medium held by a player, first selection information for selecting a first game related data item from the game related data items. The first selecting unit selects, based on the first selection information read out by the reading unit, the first game related data item from the game related data items stored in the storage unit. The first providing unit provides the player with game related information corresponding to the first game related data item selected by the first selection unit.

In this first aspect, based on the first selection information recorded in the recording medium held by a player, the first game related data item is selected from the game related data items stored in the storage unit, and the game related information corresponding to the first game related data item is provided to the player. Accordingly, a recording medium, which records selection information for selecting a game related data item, is held by the player and subjected to reading of the gaming machine, so that game related information, which corresponds to the selected game related data and is suitable for each player, can easily and surely be provided.

According to a second aspect of the present invention, there is provided a game system including one or more gaming machines and a server connected in communication with the gaming machines. Each of the gaming machines has a game related data item storage unit, a reading unit, an identification information transmitting unit, a game history data item receiving unit, a game related data item selecting unit, and a providing unit. The game related data item storage unit stores game related data items. The reading unit reads out, from a recording medium held by a player, identification information of the player. The identification information transmitting unit transmits to the server the identification information read out by the reading unit. The game history data item receiving unit receives a game history data item of the player transmitted from the server. The game related data item selecting unit selects, based on the game history data item received by the game history data item receiving unit, one or more from the game related data items stored in the game related data item storage unit. The providing unit provides the player with game related information corresponding to the game related data item selected by the game related data item selecting unit. The server has a game history data item storage unit, an identification information receiving unit, a game history data item selecting unit, and a game history data item transmitting unit. The game history data item storage unit stores game history data items of players. The identification information receiving unit receives the identification information transmitted from any one of the gaming machines. The game history data item selecting unit selects, based on the identification information received by the identification information receiving unit, one from the game history data items stored in the game history data item storage unit. The game history data item transmitting unit transmits to the one of the gaming machines the game history data item selected by the game history data item selecting unit.

According to a third aspect of the present invention, there is provided a game system including one or more gaming machines and a server connected in communication with the gaming machines. Each of the gaming machines has a reading unit, an identification information transmitting unit, a game related data item receiving unit, and a providing unit. The reading unit reads out, from a recording medium held by a player, identification information of the player. The identification information transmitting unit transmits to the server the identification information read out by the reading unit. The game related data item receiving unit receives a game related data item transmitted from the server. The providing unit provides the player with game related information corresponding to the game related data item received by the game related data item receiving unit. The server has a storage unit, an identification information receiving unit, a game history data item selecting unit, a game related data item selecting unit, and a game related data item transmitting unit. The storage unit stores game related data items and game history data items of players. The identification information receiving unit receives the identification information transmitted from any one of the gaming machines. The game history data item selecting unit selects, based on the identification information received by the identification information receiving unit, one from the game history data items stored in the storage unit. The game related data item selecting unit, based on the game history data item selected by the game history data item selecting unit, selects one or more from the game related data items stored in the storage unit. The game related data item transmitting unit transmits to the one of the gaming machines the game related data item selected by the game related data item selecting unit.

In these second and third aspects, based on the identification information of a player recorded in a recording medium held by the player, one game history data item is selected from the game history data items of players via communication between a gaming machine and a server. Based on this game history data item, then, one or more game related data items are selected, and the game related information corresponding to the game related data items thus selected is provided. Accordingly, a recording medium, which records identification information distinctive of each player, is held by the player and subjected to reading of the gaming machine. Due to this, similarly to the first aspect, game related information suitable for each player can easily and surely be provided based on a game history data item corresponding to the identification information.

### BRIEF DESCRIPTION OF THE DRAWINGS

Other and further objects, features and advantages of the invention will appear more fully from the following description taken in connection with the accompanying drawings in which:

FIG. 1 is a perspective view of a slot machine according to an embodiment of a gaming machine of the present invention;

FIG. 2 schematically illustrates a video reel of the slot machine;

FIG. 3 schematically illustrates a control panel of the slot machine;

FIG. 4A is a perspective view of a reading/writing unit of the slot machine;

FIG. 4B is a sectional view taken along a line B-B of FIG. 4A;

FIG. 5 is a perspective view of a figure which is used in playing a game using the slot machine;

FIG. 6 is a block diagram showing an internal construction of the slot machine;

FIG. 7 is a block diagram showing an image control circuit of the slot machine;

FIG. 8 is a flowchart of a main processing which is executed in the slot machine;

FIG. 9 is a flowchart of a character image display processing of FIG. 8;

FIG. 10 is a flowchart of a game related information providing processing which is executed in the slot machine;

FIG. 11A schematically illustrates a state where a character image is displayed on a main display of the slot machine;

FIG. 11B schematically illustrates a state where a basic method for operating the machine is displayed on a sub display of the slot machine;

FIG. 11C schematically illustrates a state where a basic game procedure is displayed on the sub display of the slot machine;

FIG. 12 illustrates a construction of an embodiment of a game system according to the present invention;

FIG. 13 is a block diagram showing an internal construction of the game system;

FIG. 14 is a block diagram showing an internal construction of a server of the game system;

FIG. 15 is a flowchart of a character image display processing which is executed in the game system; and

FIG. 16 is a flowchart of a game history data item update processing which is executed in the game system.

FIG. 17 is a flowchart of a character image display processing which is executed in a game system of a modification.

### DESCRIPTION OF THE PREFERRED EMBODIMENTS

In the following, a preferred embodiment of the present invention will be described with reference to the accompanying drawings.

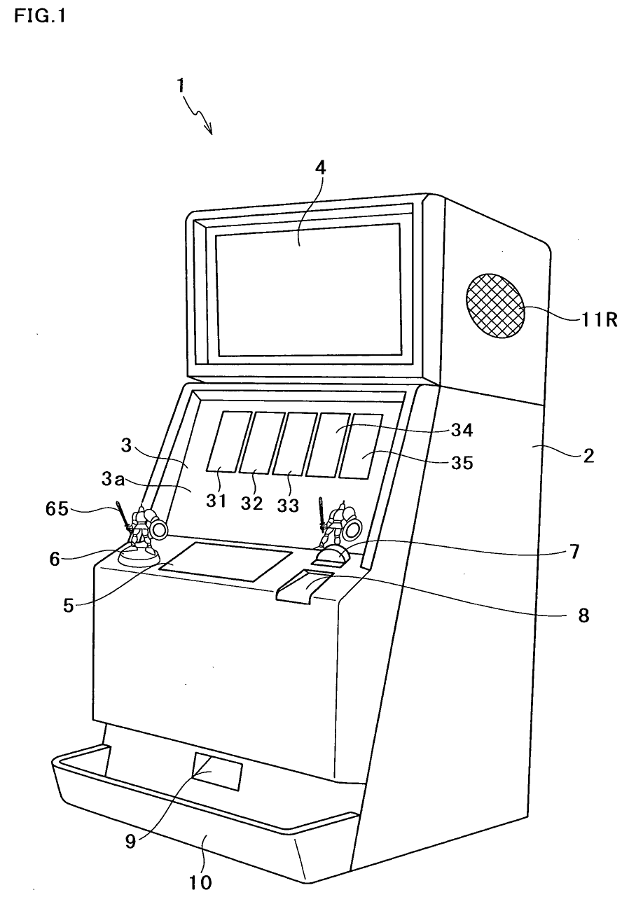

First, referring to FIG. 1, a description will be given to an external configuration of a slot machine 1 according to an embodiment of the gaming machine of the present invention. The slot machine 1 of this embodiment includes a cabinet 2, a main display 3, a touch panel 3a, a sub display 4, a control panel 5, a reading/writing unit 6, a coin insertion slot 7, a bill insertion slot 8, a coin payout opening 9, a coin tray 10, and speakers. The main display 3 locates in the middle of a front face of the cabinet 2. The touch panel 3a is provided on a screen of the main display 3. The sub display 4 locates at an upper part of the front face of the cabinet 2. The control panel 5 locates below the main display 3 and protrudes frontward. The reading/writing unit 6 locates on a left side of the control panel 5. The coin insertion slot 7 and the bill insertion slot 8 locate on a right side of the control panel 5. The coin payout opening 9 and the coin tray 10 locate at a lower part of the front face of the cabinet 2. The coin tray 10 receives a coin paid out from the coin payout opening 9. The speakers locate on both side faces of the upper part of the cabinet 2 (although FIG. 1 illustrates only the right speaker 11R).

The main display 3 displays, on its screen, five video reels 31, 32, 33, 34, and 35. In each of the video reels 31 to 35, various symbols are variably displayed while scrolling from top to bottom, and then stopped. Games including a base game and a bonus game in the slot machine 1 are played through the video reel 31 to 35.

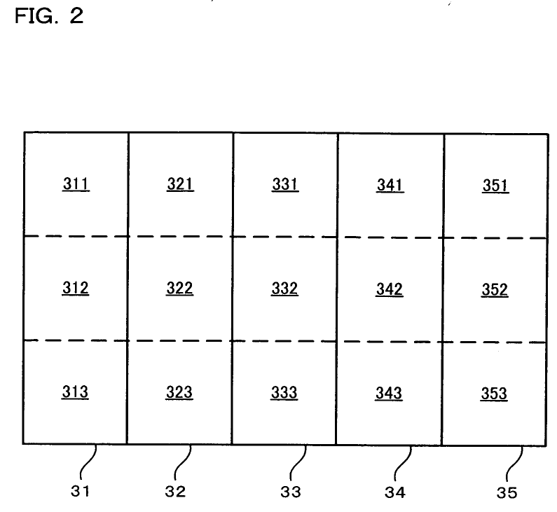

As shown in FIG. 2, each of the video reels 31 to 35 has three stop areas, in which various symbols are respectively stopped and displayed. To be more specific, the video reel 31 has stop areas 311, 312, and 313, the video reel 32 has stop areas 321, 322, and 323, the video reel 33 has stop areas 331, 332, and 333, the video reel 34 has stop areas 341, 342, and 343, and the video reel 35 has stop areas 351, 352, and 353. A pay line is made up of five areas in total, each of which is from each of the video reels 31 to 35 (e.g., made up of the stop area 312 of the video reel 31, the stop area 322 of the video reel 32, the stop area 332 of the video reel 33, the stop area 342 of the video reel 34, and the stop area 352 of the video reel 35). In this embodiment, for example, twenty-five pay lines are provided, and a payout is determined based on a combination of symbols stopped on the pay line.

The main display 3 or the sub display 4 displays, on its screen, game related information in the form of an image, and the speakers 11L and 11R outputs game related information in the form of a sound.

Game related information includes information directly related to a game, and information related to a game effect for amusing and entertaining a player. The information directly related to a game is, for example, a method for operating the slot machine 1, game contents, game procedures, kinds of winning combinations, payouts for winning combinations, credits, images on the video reels 31 to 35, the number of games, game hours, a game history of a player (such as the number of games played, game hours, the number of coins obtained), etc. The information related to a game effect is, for example, character images, sound effects, etc. Among the game related information, one which can be visually communicated is displayed on the screen of the main display 3 or the sub display 4 so that a player is provided with the information in the form of an image (such as a text image, a character image, etc.). On the other hand, one which can be audially communicated is outputted from the speakers 11L and 11R so that a player is provided with the information in the form of a sound.

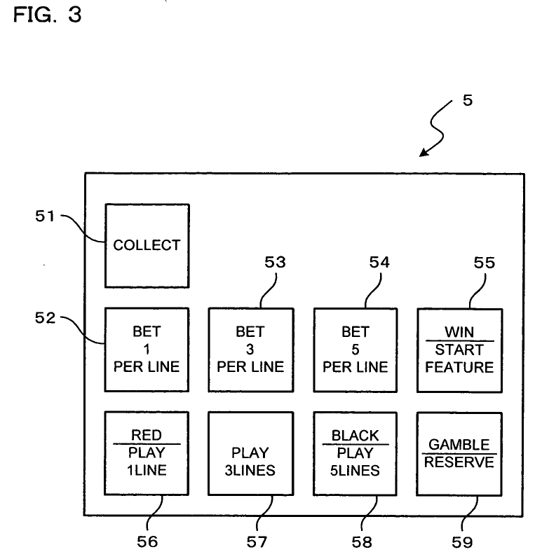

As shown in FIG. 3, an upper section of the control panel 5 has a COLLECT button 51, a middle section thereof has, from left to right, a BET 1 PER LINE button 52, a BET 3 PER LINE button 53, a BET 5 PER LINE button 54, and a WIN/START FEATURE button 55, and a lower section thereof has, from left to right, a RED/PLAY 1 LINE button 56, a PLAY 3 LINES button 57, a BLACK/PLAY 5 LINES button 58, and a GAMBLE/RESERVE button 59.

The COLLECT button 51 is pressed at the end of a base game. When the COLLECT button 51 is pressed, coins equivalent to the credit amount are paid out from the coin payout opening 9 into the coin tray 10. The BET 1 PER LINE button 52, the BET 3 PER LINE button 53, and the BET 5 PER LINE button 54 are buttons which, upon one press, increase the bet on each activated pay line by one, three, and five, respectively. The WIN/START FEATURE button 55 is a button for starting a bonus game and for adding to the credit a payout obtained in a bonus game. The RED/PLAY 1 LINE button 56 is a button for starting a game with one activated pay line. The PLAY 3 LINES button 57 is a button for starting a game with three activated pay lines. The BLACK/PLAY 5 LINES button 58 is a button for starting a game with five activated pay lines. The GAMBLE/RESERVE button 59 is a button which is pressed when a player leaves a seat and which is pressed in order to shift to a double-down game after a bonus game is finished.

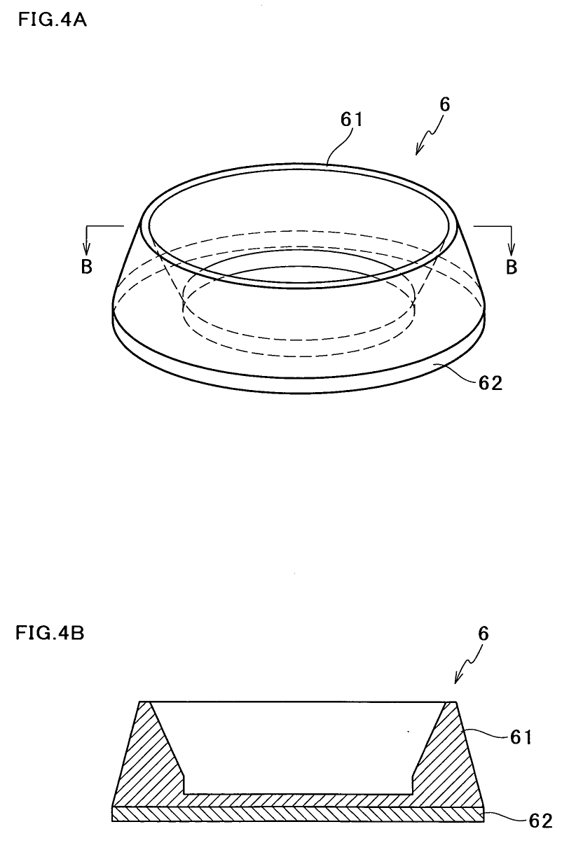

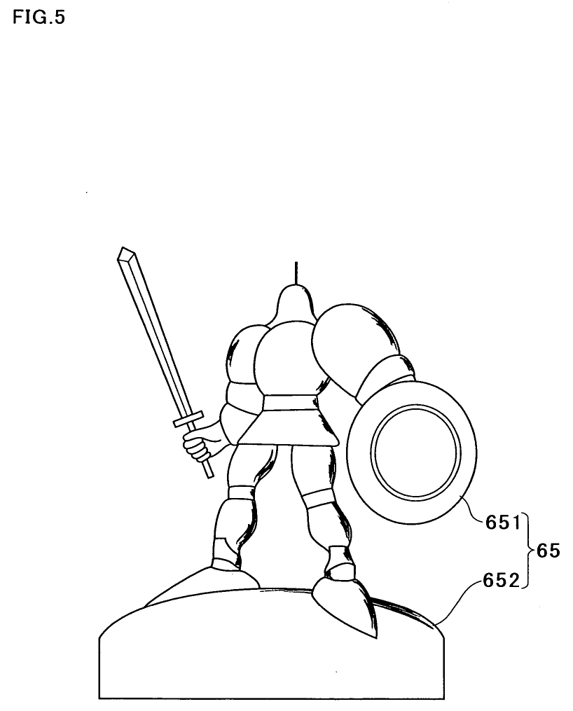

As shown in FIGS. 4A and 4B, the reading/writing unit 6 includes a frame 61 that holds a FIG. 65 shown in FIG. 5, and a wireless tag reader/writer 62 that are provided below the frame 61.

As shown in FIG. 5, the FIG. 65 has a figure main body 651 presenting a 3-D character, a base 652, and a wireless tag (not shown) provided inside the base 652.

Referring to FIG. 4, the frame 61 of the reading/writing unit 6 has a concavity a diameter of which is slightly larger than a diameter of the base 652 of the FIG. 65, so that the frame 61 can hold the FIG. 65 when the base 652 is fitted into the concavity.

The wireless tag of the FIG. 65 has a memory, an RF circuit and antenna for wireless communication, and a logic circuit for connecting them. The memory stores a game history data item of a player to which the FIG. 65 belongs. A game history data item of a player stored in the memory is related to a history of games which the player has played using other slot machines before he/she plays the current machine 1, and sometimes referred to as a “pre-starting history data item” hereinafter. This data item is one reflective of a skill level in a game of a player, such as the total number of games played, total game hours, the total number of coins obtained, etc. The data item is used for classifying a player as a beginner, an intermediate, or an advanced. Based on the total number of games played, for example, a player may be-classified as the beginner when the total number of game played is 0 to 200, as the intermediate when the total number of game played is 201 to 1000, and as the advanced when the total number of game played is 1001 or more. Based on total game hours, alternatively, a player may be classified as the beginner when the total game hours are less than 100, as the intermediate when the total game hours are 100 to 200, and as the advanced when the total game hours are more than 200.

The wireless tag reader/writer 62 of the reading/writing unit 6 transmits a radio signal to the wireless tag of the FIG. 65, and receives a responsive radio signal transmitted from the wireless tag. Thereby, the wireless tag reader/writer 62 can read out a pre-starting history data item stored in the wireless tag of the FIG. 65, and at the same time can transmit a radio signal to the wireless tag of the FIG. 65 in order to write into the wireless tag of the FIG. 65 a game history data item after updated in association with progress of a game.

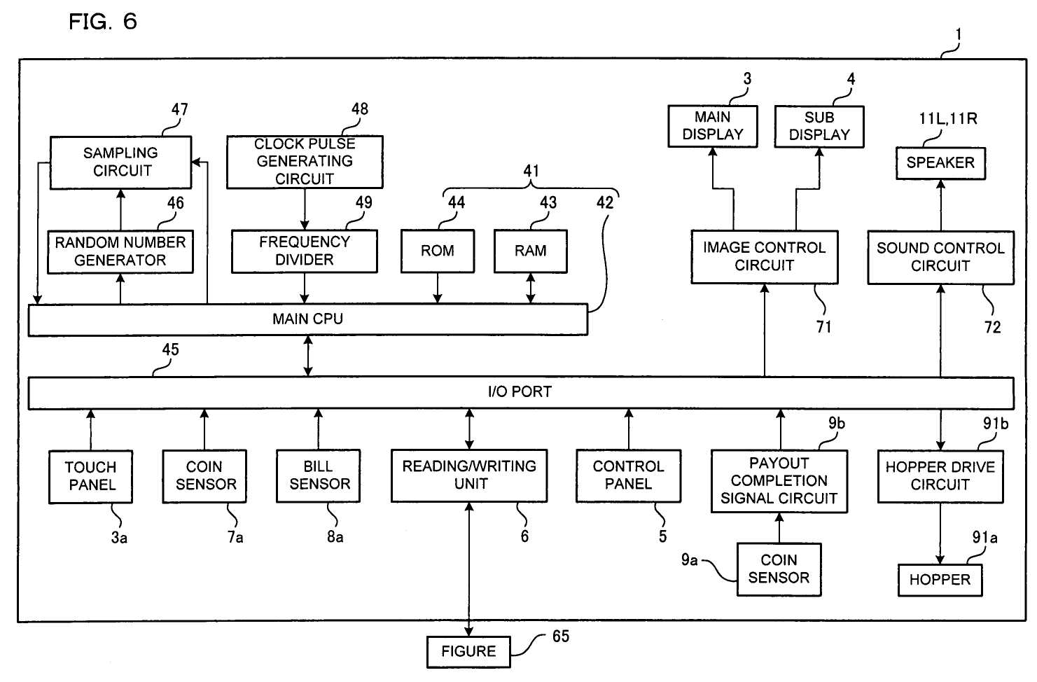

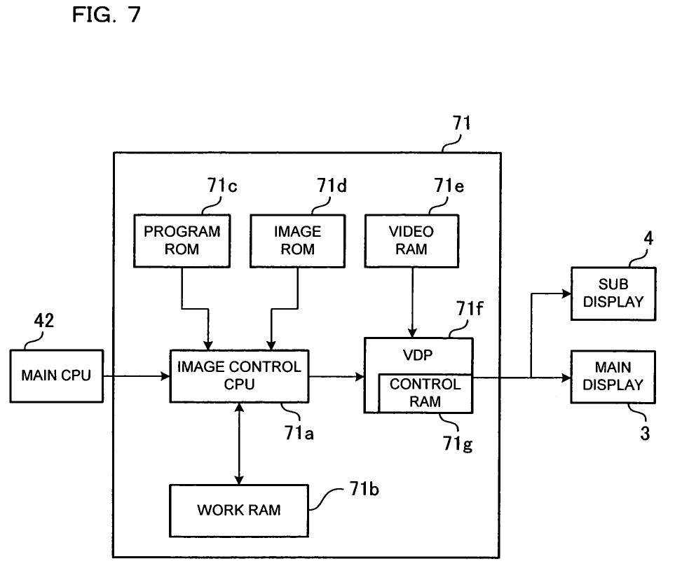

Next, an internal construction of the slot machine 1 will be described with reference to FIGS. 6 and 7.

As shown in FIG. 6, the slot machine 1 includes a microcomputer 41 having a main CPU (Central Processing Unit) 42, a RAM (Random Access Memory) 43 and a ROM (Read Only Memory) 4, an I/O port 45, a random number generator 46, a sampling circuit 47, a clock pulse generating circuit 48, a frequency divider 49, a control panel 5, a touch panel 3a, a reading/writing unit 6, an image control circuit 71, a sound control circuit 72, a coin sensor 7a, a bill sensor 8a, a hopper 91a, a hopper drive circuit 91b, a coin sensor 9a, and a payout completion signal circuit 9b.

The main CPU 42 works in accordance with a program stored in the ROM 44. The main CPU 42 inputs and outputs signals with the members provided in the cabinet 2 via the I/O port 45, and thereby controls operation of the whole of the slot machine 1. As a game progresses, the main CPU 42 updates a game history data item of a player. At this time, if necessary, the main CPU 42 uses a pre-starting history data item read out from the FIG. 65. For example, the main CPU 42 uses a pre-starting history data item read out from the FIG. 65, in order to update data items such as the total number of games played, total game hours, the total number of coins obtained, etc. However, when updating data items about the number of games, game hours, the number of coins obtained, etc., in the current slot machine 1, the pre-starting history data item read out from the FIG. 65 are not used.

The ROM 44 stores a control program which is executed by the main CPU 42, permanent data items, and the like. The ROM 44 stores, for example, a program for identifying a player as any of the beginner, the intermediate, and the advanced based on a pre-starting history data item, a program for generating a signal based on which a predetermined image data item or sound data item is selected among many image data items or many sound data items, a program for updating a game history data item of a player as a game progresses, and the like.

The RAM 43 stores data items, programs, etc., which are used when the main CPU 42 operates. The RAM 43 stores a game history data item read out from the FIG. 65 by the reading/writing unit 6, for example.

The random number generator 46 works in accordance with a command from the main CPU 42, and generates a random number in a predetermined range. In accordance with a command from the main CPU 42, the sampling circuit 47 extracts an arbitrary one from random numbers generated by the random number generator 46, and then outputs the extracted random number to the main CPU 42.

The clock pulse generating circuit 48 generates a reference clock used for operation of the main CPU 42. The frequency divider 49 outputs, to the main CPU 42, a signal obtained by dividing the reference clock by a predetermined cycle.

The control panel 5 outputs, to the main CPU 42, a signal inputted upon a press of each of the buttons 51 to 59. Based on this signal, the main CPU 42 activates a pay line, executes a starting processing of a slot game and outputs to the image control circuit 71 a signal for variably displaying symbols on each of the video reels 31 to 35 of the main display 3 while scrolling the symbols from top to bottom.

The touch panel 3a is provided so as to cover the screen of the main display 3. The touch panel 3a detects a portion a player touches with his/her finger, etc., and outputs a detection signal to the main CPU 42. The touch panel 3a is, for example, a rectangular transparent plate having a conductive material applied on its surface. Voltage is applied through electrodes which are disposed at four corners of the transparent plate, and the electrodes detect a faint change of current which is caused upon a touch of a finger, etc., of a player, so that a portion where the finger, etc., of the player touches is detected.

The reading/writing unit 6 reads out a game history data item stored in the memory of the wireless tag of the FIG. 65 which is held on the frame 61, and then outputs the game history data item to the main CPU 42. The game history data item outputted to the main CPU 42 is temporarily stored in the RAM 43.

As shown in FIG. 7, the image control circuit 71 includes an image control CPU 71a, a work RAM 71b, a program ROM 71c, an image ROM 71d, a video RAM 71e, and a VDP (Video Display Processor) 71f.

The image control circuit 71 controls an image display on each of the displays 3 and 4, and displays images on the main display 3 or on the sub display 4.

The image control CPU 71a works in accordance with an image control program stored in the program ROM 71c, and determines images which will be displayed on the displays 3 and 4.

The program ROM 71c stores an image control program, various selection tables, etc. The program ROM 71c stores, for example, a program for, in accordance with a command from the main CPU 42, selecting a predetermined image data item from image data items stored in the image ROM 71d and then displaying an image based on the selected image data item on the main display 3 or on the sub display 4, a program for generating an image data item in accordance with a command from the main CPU 42, and the like.

The image ROM 71d stores image data items about various game related information, dot data items for forming images, and the like. The image data items about game related information stored in the image ROM 71d include image data items about information essential for playing a game in the slot machine 1 (e.g., image on the video reels 31 to 35, etc.), and image data items about information which is additionally provided to a player when he/she plays a game in the slot machine 1 (e.g., a method for operating the slot machine 1, game contents, game procedures, a game history of a player, character images, sound effects, etc.).

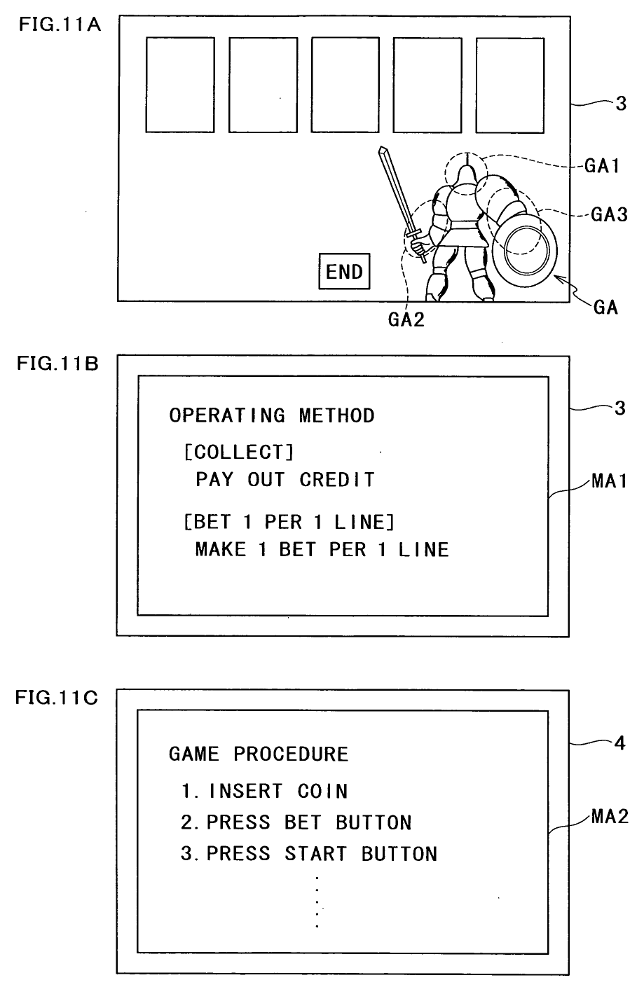

The image data items about information which is additionally provided are classified into one intended for the beginner, one for intended for the intermediate, and one intended for the advanced. At each of the beginner level, the intermediate level, and the advanced level, the character image data item is associated with game related image information such as a method for operating the slot machine 1, game contents, game procedure, etc. To be more specific, one or more kinds of game related image data items are associated with respective parts GA1, GA2, and GA3 of a character image GA which corresponds to a character image data item and is displayed on the main display 3 as shown in FIG. 11A.

The game related image data items intended for the beginner include, for example, image data items about game related information intended for the beginner such as a basic method for operating the slot machine 1, basic game contents, basic game procedures, and the like. The game related image data items intended for the intermediate include, for example, image data items about game related information intended for the intermediate such as a special method for operating the slot machine 1, special game contents, special game procedures, and the like. The game related image data items intended for the advanced include, for example, image data items about game related information intended for the advanced such as high-level game techniques for obtaining an increased number of coins.

The game related image data items may include, for example, image data items about game related information needed by any-level player, such as a game history of a player, the current time, and the like.

The video RAM 71e functions as a temporary storage unit which is used when the VDP 71f forms an image. The VDP 71f has a control RAM 71g. The VDP 71f forms images corresponding to contents displayed on the main display 3 and the sub display 4, which are determined by the image control CPU 71a. Then, the VDP 71f outputs the images thus formed to the main display 3 and the sub display 4, respectively.

The sound control circuit 72 has a sound control CPU, a sound ROM, and a sound RAM. The sound control circuit 72 generates a sound signal for outputting a sound from the speakers 11L and 11R, and then inputs the sound signal to the speakers 11L and 11R so that a sound is outputted from the speakers 11L and 11R. The sound control CPU works in accordance with a sound control program stored in the sound ROM, and determines a sound which will be outputted from the speakers 11L and 11R. The sound ROM stores sound data items about game related information as well as a sound control program and various selection tables. The sound ROM stores, for example, sound data items about various game related information, a program for selecting a predetermined sound data item from sound data items stored in the sound ROM in accordance with a command from the main CPU 42 so that a sound based on the selected sound data item can be outputted from the speakers 11L and 11R, and the like.

The sound data items about game related information stored in the sound ROM are sound data items about information which is additionally provided to a player when he/she plays a game in the slot machine 1 (e.g., a method for operating the slot machine 1, game contents, game procedures, a game history of a player, character images, sound effects, etc.).

The sound data items about information which is additionally provided are, similarly to the image data items stored in the image ROM 71d, classified into one intended for the beginner, one intended for the intermediate, and one intended for the advanced. At each of the beginner level, the intermediate level, and the advanced level, the sound data items include game related sound data items which are associated with a character image data item selected in each of the levels. To be more specific, one or more kinds of game related sound data items are associated with respective parts GA1, GA2, and GA3 of a character image GA which corresponds to a character image data item and is displayed on the main display 3 as shown in FIG. 11A.

The game related sound data items intended for the beginner include, for example, sound data items about game related information intended for the beginner such as a basic method for operating the slot machine 1, basic game contents, basic game procedures, and the like. The game related sound data items intended for the intermediate include, for example, sound data items about game related information intended for the intermediate such as a special method for operating the slot machine 1, special game contents, special game procedures, and the like. The game related sound data items intended for the advanced include, for example, sound data items about game related information intended for the advanced such as high-level game techniques for obtaining an increased number of coins.

Similarly to the game related image data items stored in the image ROM 71d, the game related sound data items may include, for example, sound data items about game related information needed by any-level player, such as a game history of a player, the current time, and the like.

The coin sensor 7a detects a coin inserted through the coin insertion slot 7, and then outputs to the main CPU 42 a coin detection signal corresponding to its detection. Based on the coin detection signal, the main CPU 42 calculates the number of coins inserted, and adds a credit equivalent to the number of coins.

The bill sensor 8a detects a kind and an amount of bill inserted through the bill insertion slot 8, and then outputs to the main CPU 42 a bill detection signal corresponding to its detection. Based on the bill detection signal, the main CPU 42 calculates a credit value equivalent to the amount of bills inserted, and adds the calculated credit value.

The hopper 91a is connected via the hopper drive circuit 91b to the main CPU 42. When a drive signal is outputted from the main CPU 42 to the hopper drive circuit 91b, the hopper 91a pays out a predetermined number of coins from the coin payout opening 9.

The coin sensor 9a is, though not illustrated in FIG. 1, provided in a passage which locates within the cabinet 2 of the slot machine 1 and extends to the coin payout opening 9. The coin sensor 9a detects a coin paid out from the coin payout opening 9, and outputs to the payout completion signal circuit 9b a coin detection signal corresponding to its detection. Based on the coin detection signal, the payout completion signal circuit 9b calculates the number of coins paid out. When the number of coins paid out reaches a predetermined value, the payout completion signal circuit 9b outputs a payout completion signal to the main CPU 42.

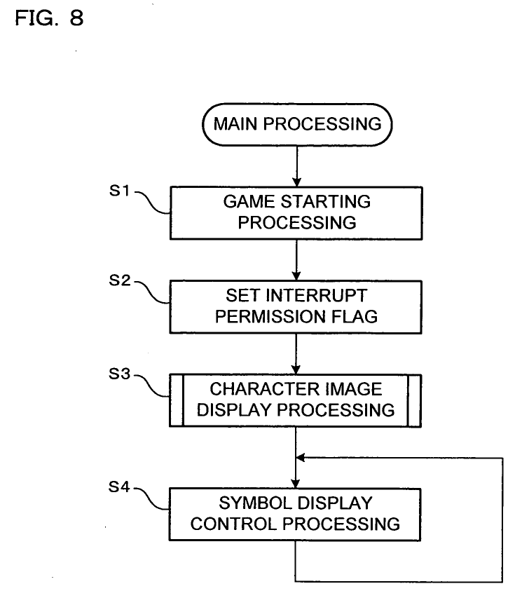

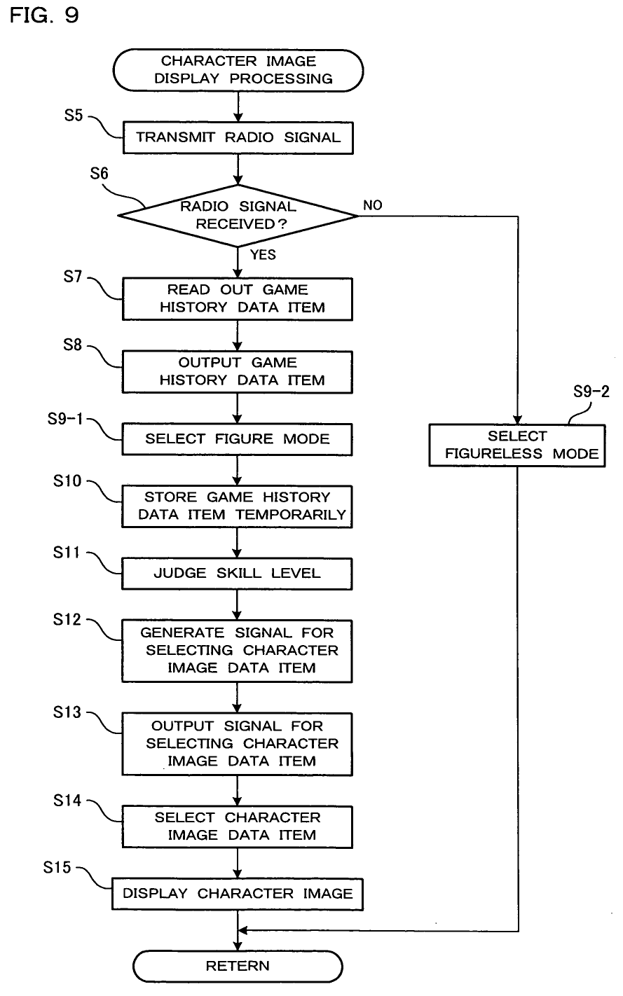

Next, processings executed in the slot machine 1 will be described with reference to FIGS. 8 and 9.

First, a main processing shown in FIG. 8 will be described. When a player inserts a coin into the coin insertion slot 7 or presses each of the buttons 51 to 59 of the control panel 5, the main CPU 42 executes a game starting processing (S1). After the game starting processing, the main CPU 42 sets an interrupt permission flag (S2). After setting the interrupt permission flag, the main CPU 42 executes a character image display processing (S3).

In the character image display processing (S3), first, the main CPU 42 causes the wireless tag reader/writer 62 of the reading/writing unit 6 to transmit a radio signal to the wireless tag of the FIG. 65 (S5), as shown in FIG. 9.

If the FIG. 65 is held on the reading/writing unit 6, the wireless tag of the FIG. 65 receives the radio signal transmitted from the wireless tag reader/writer 62 of the reading/writing unit 6, and then transmits a responsive radio signal to the wireless tag reader/writer 62. The wireless tag reader/writer 62 receives the radio signal from the wireless tag of the FIG. 65 (S6: Yes) to read out a game history data item stored in the wireless tag of the FIG. 65 (S7), and then outputs the game history data item thus read out to the main CPU 42. When the wireless tag reader/writer 62 outputs a game history data item to the main CPU 42, the main CPU 42 judges that the FIG. 65 is held on the reading/writing unit 6 and selects a figure mode as a mode of the slot game (S9-1).

If the FIG. 65 is not held on the reading/writing unit 6, the wireless tag reader/writer 62 does not receive the radio signal from the wireless tag of the FIG. 65 (S6: No), and therefore a game history data item is not outputted to the main CPU 42. Since no game history data item is outputted to the main CPU 42, the main CPU 42 judges that the FIG. 65 is not held on the reading/writing unit 6 and selects a figureless mode as a mode of the slot game (S9-2).

If the figureless mode is selected (S9-2), the main CPU 42 exits from the character image display processing and at the same time shows, on the main display 3, that the figureless mode is selected and that the FIG. 65 must be set on the reading/writing unit 6 in order to select the figure mode. As long as the figureless mode is kept, a player cannot get game related information that corresponds to his/her skill level although he/she can play a game in the slot machine 1.

If the figure mode is selected (S9-1), the game history data item read out by the reading/writing unit 6 is temporarily stored in the RAM 43 (S10). Based on the game history data item stored in the RAM 43, the main CPU 42 judges the player to be any one of the beginner, the intermediate, and the advanced (S11), then generates a signal for selecting a character image data item that corresponds to the skill level of the player (S12), and then outputs this signal to the image control circuit 71 (S13).

Based on the character image selecting signal outputted from the main CPU 42, the image control CPU 71a of the image control circuit 71 selects, from image data items stored in the image ROM 71d, a character image data item corresponding to the skill level of the player (S14). A character image GA corresponding to the selected character image data item is, as shown in FIG. 11A, displayed at a lower-right of the main display 3. A text image of “END” is displayed on a left side of the character image GA (S15).

Each part of the character image GA (e.g., a head GA1, a right arm GA2, a left arm GA3, etc.) displayed on the main display 3 is associated with one or more kinds of game related image data items or game related sound data items which belong to the same skill level.

After the character image is displayed at the lower-right of the main display 3, the main CPU 42 exits from the character image display processing.

After the character image display processing ends, the main CPU 42 executes a symbol display control processing (S4). In the symbol display control processing (S4), the main CPU 42 determines a winning combination or losing combination based on a random number generated by the random number generator 46 and extracted by the sampling circuit 47. Then, the main CPU 42 variably displays symbols, which are scrolling from top to bottom, on each of the video reels 31 to 35 of the main display 3. After a predetermined period of time elapses, symbols giving the determined winning or losing combination are stopped. If a combination of symbols stopped on an activated pay line is a winning combination, a payout assigned to this winning combination is added to the credit. The main CPU 42 repeats this symbol display control processing (S4).

While a player is playing a game in the slot machine 1, the main CPU 42 updates a game history data item of the player as the game progresses. For example, if a player inserts a coin into the coin insertion opening 7 or presses each of the BET buttons 52 to 54, and then presses each of the PLAY buttons 56 to 58, an input signal is outputted from the control panel 5 to the main CPU 42, so that the main CPU 42 updates the data items about the number of games played, the total number of games played, etc., which are stored in the RAM 43. For example, in a case where the number of games played before pressing each of the PLAY buttons 56 to 58 is 156, it is updated into 157 when an input signal is outputted to the main CPU 42. The main CPU 42 also updates a data item about the current time.

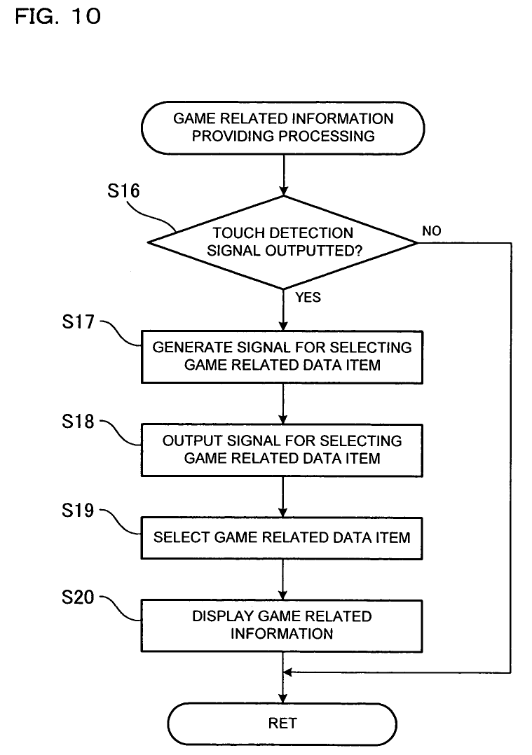

Next, a game related information providing processing executed in the slot machine 1 will be described with reference to FIG. 10. The game related information providing processing is executed under the condition that the interrupt permission flag is set in the main processing of FIG. 8 (S2).

First, the main CPU 42 judges whether a touch detection signal is outputted from the touch panel 3a to the main CPU 42 (S16). When a player needs to get game related information in the process of the slot game, he/she touches a part of the character image GA displayed on the main display 3, so that the touch panel 3a detects the touched part and a touch detection signal is outputted from the touch panel 3a to the main CPU 42 (S16: Yes). On the other hand, if the touch detection signal is not outputted from the touch panel 3a to the main CPU 42 (S16: No), the main CPU 42 exits from the game related information providing processing.

After the touch detection signal is outputted from the touch panel 3a to the main CPU 42 (S16: Yes), the main CPU 42 generates a signal for selecting a game related image data item or a game related sound data item which is associated with the detected part (S17), and then outputs this signal to the image control circuit 71 or the sound control circuit 72 (S18). Here, if the game related image data item or the game related sound data item which is associated with the part touched by the player is an image or sound data item about a game history of the player, the main CPU 42 generates a signal for selecting an image or sound data item about the latest game history data item and then outputs this signal to the image control circuit 71 or the sound control circuit 72.

Based on the signal outputted from the main CPU 42, the image control circuit 71 selects, from image data items stored in the image ROM 71d, an image data item about predetermined game related information (S19). Based on the selected image data item, the image control circuit 71 displays the game related information on the sub display 4 as shown in FIG. 11B and 11C (S20). Based on the signal outputted from the main CPU 42, the sound control circuit 72 selects, from sound data items stored in the sound ROM, a sound data item about predetermined game related information (S19). Based on the selected sound data item, the sound control circuit 72 outputs from the speakers 11L and 11R the game related information in the form of sound.

For example, referring to 11A, in a case where the head GA1, the right arm GA2, and the left arm GA3 of the character image GA are associated with an image data item about the basic method for operating the slot machine 1, an image data item about the basic game contents, and an image data item about the basic game procedures, respectively, a player's touch to the head GA1 of the character image GA causes the main CPU 42 to generate a signal for selecting an image data item about the basic method for operating the slot machine 1 and to output the signal thus generated to the image control circuit 71. Based on this signal, the image control circuit 71 generates an image data item about the basic method for operating the slot machine 1, and displays on the sub display 4 a text image MA1 about the basic method for operating the slot machine 1, as shown in FIG. 11B. A player's touch to the left arm GA3 of the character image GA causes the main CPU 42 to generate a signal for selecting an image data item about the basic game procedures and to output the signal thus generated to the image control circuit 71. Based on this signal, the image control circuit 71 selects an image data item about the basic game procedures from image data items stored in the image ROM 71d, and displays on the sub display 4 a text image MA2 about the basic game procedure, as shown in FIG. 11C. When a player touches another part of the character image GA, the image displayed on the sub display 4 can be switched to another one.

When the sub display 4 displays game related information in the form of an image (S20) or when the speakers 11L and 11R output game related information in the form of a sound, the main CPU 42 exits from the game related information providing proceeding.

In order to end a game in the slot machine 1, a player touches a part indicating “END” on the screen of the main display 3, so that a game end signal is outputted from the touch panel 3a to the main CPU 42 which then stops updating a game history data item. Subsequently, the main CPU 42 outputs to the reading/writing unit 6 the game history data item updated during the game, and the reading/writing unit 6 writes the updated game history data item into the wireless tag of the FIG. 65.

During the writing into the wireless tag, in accordance with a command from the main CPU 42, the image control circuit 71 shows, at a lower part of the sub display 4, that a data item is now being written and that the FIG. 65 must not be removed. At the same time, LED lamps (not shown) arranged around the cabinet 2 light on. After the writing of the game history data item completes, the LED lamps light off, and the sub display 4 shows, at its lower part, that the writing of the data item completes.

As thus far described above, in the slot machine 1 of this embodiment, a character image data item corresponding to a skill level of a player is selected based on a game history data item stored in a FIG. 65 of the player, and a character image GA corresponding to the selected character image data item is displayed on the main display 3. Thus, game related information such as a character image GA suitable for each player (more specifically, suitable for a skill level of each player) can easily and surely be provided.

In this embodiment, moreover, when a player touches any of parts GA1, GA2, and GA3 of the character image GA, not only the character image GA suitable for the skill level but also game related information corresponding to each skill level is additionally provided through the sub display 4 and the speakers 11L and 11R. Thus, game related information needed by a player can more surely be provided.

A player can easily and quickly obtain additional game related information merely by touching the parts GA1, GA2, and GA3 of the character image GA. Further, since an image of a character and the like is displayed, a bother in inputting can be relieved, and a player can feel amused and entertained rather than bothered. If there is no need of game related information, a player need not touch the parts GA1, GA2, and GA3 of the character image GA. Thus, the player does not feel bothered about unnecessary game related information.

Since a game history data item stored in the FIG. 65 is used, a player can be provided with game related information which corresponds to his/her skill level. In addition, the reading/writing unit 6 updates a game history data item read out from the FIG. 65 and writes the updated game history data item into the FIG. 65. Therefore, if the skill level of the player is improved, game related information which corresponds to the improved level can be provided to the player.

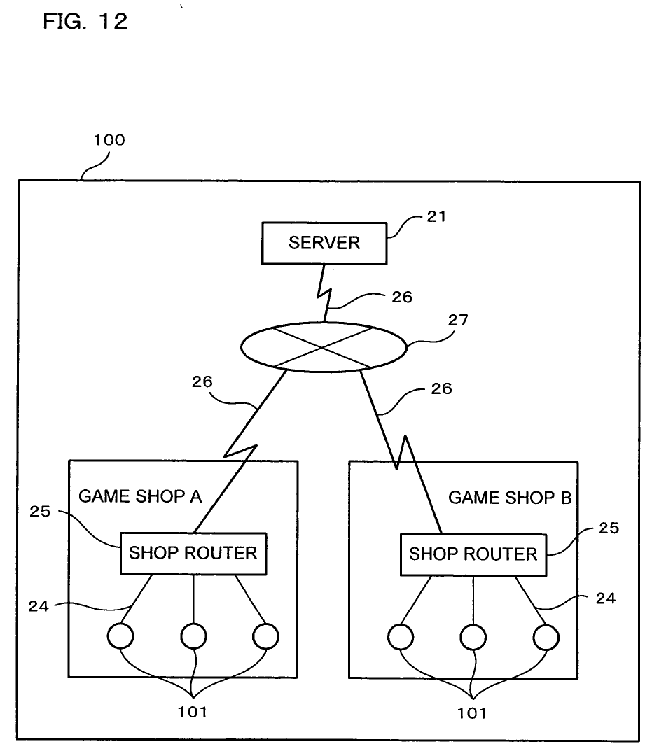

Then, a game system 100 according to an embodiment of the present invention will be described with reference to FIG. 12. The same members as those of the slot machine 1 described above will be denoted by the common reference numerals, without a specific description thereof.

Referring to FIG. 12, the game system 100 of this embodiment includes slot machines 101, shop routers 25, and a sever 21. The slot machines 101 are placed in game shops A and B. In each of the shops A and B, the shop router 25 is connected in communication with each of the slot machines 101 via a dedicated line. The server 21 is connected in communication with each of the shop routers 25 via a communication line 26 and an internet 27.

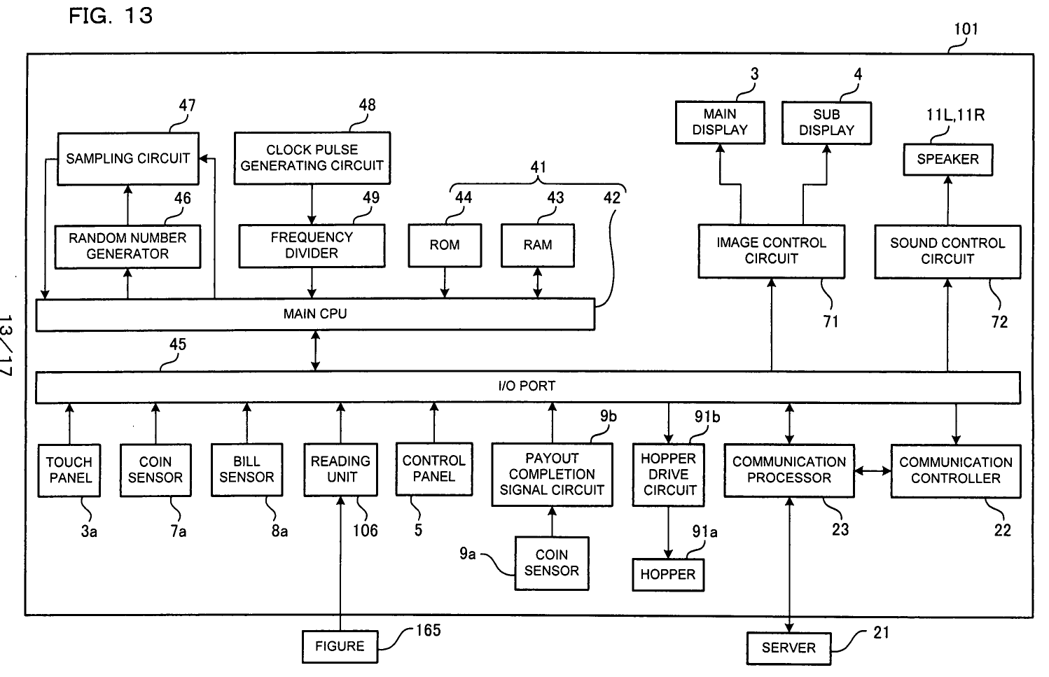

A construction of the slot machine 101 is substantially the same as that of the slot machine 1. As shown in FIG. 13, however, a reading unit 106 replaces the reading/writing unit 6 of the slot machine 1 (see FIG. 6), and further a communication processor 23 and a communication controller 22 are additionally provided in order to communicate with the server 21. The ROM 44 further stores a program for making the communication controller 22 and the communication processor 23 perform transmission and reception of data items between the slot machine 101 and the server 21.

A construction of the reading unit 106 is the same as that of the reading/writing unit 6 shown in FIGS. 4A and 4B, except that a wireless tag reader instead of the wireless tag reader/writer 62 is provided under the frame 61.

A FIG. 165 is different from the FIG. 65 in that a memory of its wireless tag stores identification information for identifying a player. The identification information recorded in one FIG. 165 is different from that in another FIG. 165, and here the identification information is exemplified by an ID number. Based on the ID number, the server 21 selects one from game history data items of players which are stored in the server 21.

The RAM 43 stores an ID number which has been read out from the wireless tag of the FIG. 165 by the reading unit 106, a game history data item transmitted from the server 21, and the like.

When updating data items about variable information (e.g., a game history of a player) which is varying over time as a game progresses, a main CPU 42, if necessary, uses a pre-starting history data item transmitted from the server 21 as will be described later. For example, the main CPU 42 uses a pre-starting history data item transmitted from the server 21, in order to update data items such as the total number of games played, total game hours, the total number of coins obtained. However, when updating data items about the number of games, game hours, the number of coins obtained, etc., in the current slot machine 101, the pre-starting history data item transmitted from the server 21 is not used.

The reading unit 106 reads out an ID number stored in the memory of the wireless tag of the FIG. 165 which is held on the reading unit 106, and then outputs the ID number to the main CPU 42. The ID number thus outputted to the main CPU 42 is then outputted from the main CPU 42 to the communication processor 23.

The communication controller 22 works in accordance with a command from the main CPU 42, and controls connection and disconnection of a line that is used for communication with the server 21. In accordance with a command from the communication controller 22, the communication processor 23 transmits, to the server 21, the ID number of the FIG. 165 stored in the RAM 43, the game history data item of a player updated as a game progresses in the slot machine 101, and at the same time the communication processor 23 receives a game history data item transmitted from the server 21. The game history data item received by the communication processor 23 is temporarily stored in the RAM 43.

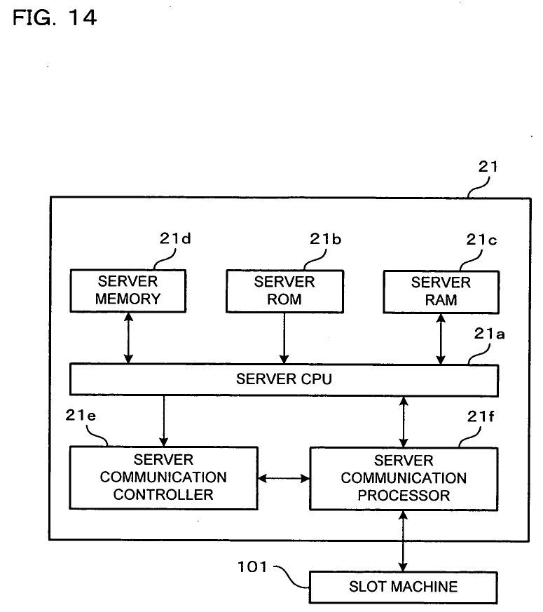

As shown in FIG. 14, the server 21 has a server CPU 21a, a server ROM 21b, a server RAM 21c, a server memory 21d, a server communication controller 21e, and a server communication processor 21f.

The server CPU 21a controls operation of the whole of the server 21 in accordance with a program stored in the server ROM 21b. The server ROM 21b stores a control program which are executed by the server CPU 21a, and permanent data items. The server RAM 21c stores data items and programs which are used when the server CPU 21a is being operated. The server RAM 21c temporarily stores an ID number of the FIG. 165 transmitted from the slot machine 101.

The server memory 21d stores game history data items of players. The game history data item stored in the server memory 21d relates to a history of games which a player has played using other slot machines before he/she plays the current machine 1, and sometimes referred to as a “pre-starting history data item”. This data item is one reflective of a skill level of a player, such as the total number of games played, total game hours, the total number of coins obtained, etc. The game history data item of each player is associated with an ID number stored in his/her figure. Based on an ID number of the FIG. 165 transmitted from the slot machine 101, the server CPU 21a selects, from the server memory 21d, a game history data item of the player. In addition, based on the game history data item of the player updated as a game progresses in the slot machine 101, the server CPU 21a updates the game history data item stored in the server memory 21d.

In accordance with a command from the server CPU 21a, the server communication controller 21e operates the server communication processor 21f. In accordance with a command from the server communication controller 21e, the server communication processor 21f transmits a data item to the slot machine 101 and receives a data item from the slot machine 101. The game history data item stored in the server memory 21d is transmitted from the server communication processor 21f to the slot machine 101. The ID number of the FIG. 165 or the game history data item updated by the slot machine 101 is transmitted from the slot machine 101, then received by the server communication processor 21f, and then temporarily stored in the server RAM 21c.

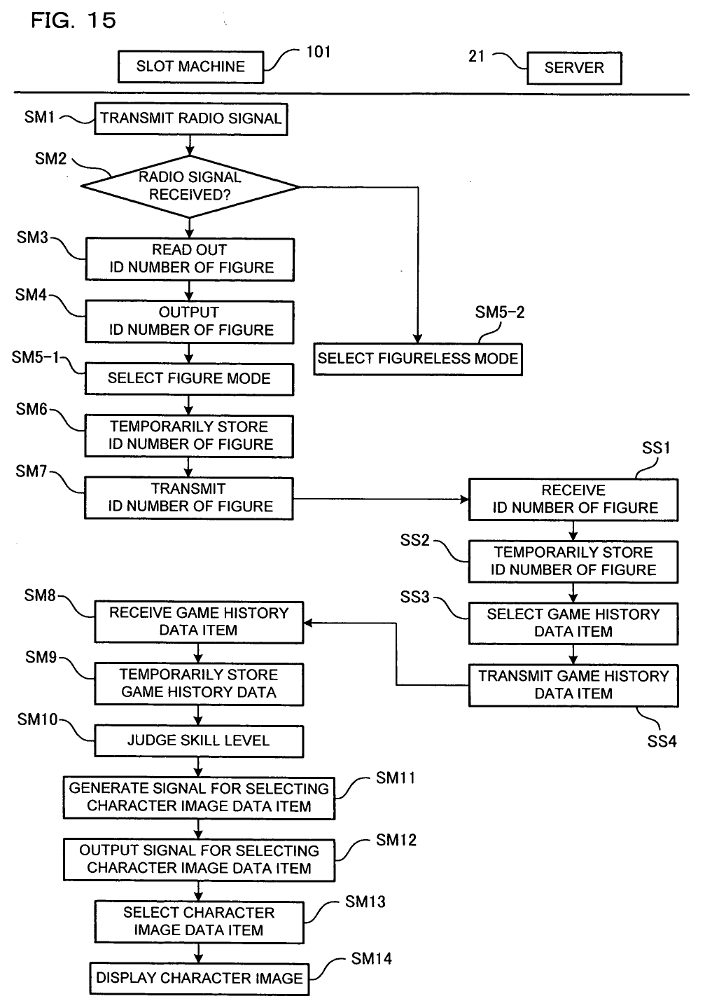

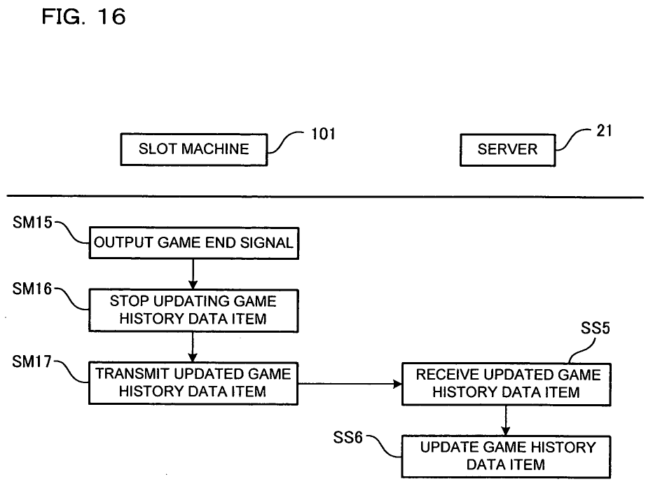

Next, processings executed in the game system 100 will be described with reference to FIGS. 15 and 16.

First, a character image display processing shown in FIG. 15 will be described. When a player inserts a coin into the coin insertion opening 7 or presses each of the buttons 51 to 59 of the control panel 5, the main CPU 42 of the slot machine 101 executes a game starting processing and then makes the reading unit 106 transmit a radio signal for reading out an ID number from the FIG. 165 (SM1).

If the FIG. 165 is held on the reading unit 106, the wireless tag of the FIG. 165 receives the radio signal transmitted from the wireless tag reader of the reading unit 106, and then transmits a responsive radio signal to the wireless tag reader. The wireless tag reader receives the radio signal from the wireless tag of the FIG. 165 (SM2: Yes) to read out an ID number stored in the wireless tag of the FIG. 165 (SM3), and then outputs the ID number thus read out to the main CPU 42 (SM4). When the wireless tag reader outputs to the main CPU 42 the ID number of the FIG. 165, the main CPU 42 judges that the FIG. 165 is held on the reading unit 106 and selects a figure mode as a mode of the slot game (SM5-1).

If the FIG. 165 is not held on the reading unit 106, the wireless tag reader does not receive the radio signal from the wireless tag of the FIG. 165 (SM2: No), and therefore the ID number of the FIG. 165 is not outputted to the main CPU 42. Since the ID number of the FIG. 165 is not outputted to the main CPU 42, the main CPU 42 judges that the FIG. 165 is not held on the reading unit 106 and selects a figureless mode as a mode of the slot game (SM5-2).

If the figureless mode is selected (SM5-2), the main CPU 42 exits from the character image display processing and at the same time shows, on the main display 3, that the figureless mode is selected and that the FIG. 165 must be set on the reading unit 106 in order to select the figure mode. As long as the figureless mode is kept, a player cannot get game related information that corresponds to his/her skill level although he/she can play a game in the slot machine 1.

If the figure mode is selected (SM5-1), the ID number of the FIG. 165 read out by the reading unit 106 is temporarily stored in the RAM 43 (SM6). In accordance with a command from the communication controller 22, the ID number stored in the RAM 43 is transmitted from the communication processor 23 to the server 21 (SM7).

The ID number of the FIG. 165 transmitted from the communication processor 23 is received by the server communication processor 21f (SS1), and temporarily stored in the server RAM 21c (SS2). Based on the ID number of the FIG. 165 stored in the server RAM 21c, the server CPU 20a selects, from game history data items of multiple players stored in a server memory 21d, a game history data item of a player to which the FIG. 165 belongs (SS3). The game history data item thus selected is, in accordance with a command from the server communication controller 21e, transmitted from the server communication processor 21f to the slot machine 101 (SS4).

The game history data item transmitted from the server 21 is received by the communication processor 23 (SM8), and temporarily stored in the RAM 43 (SM9). Based on the game history data item stored in the RAM 43, the main CPU 42 judges the player to be any one of the beginner, the intermediate, and the advanced (SM10). Then, based on the program stored in the ROM 44, the main CPU 42 generates a signal for selecting a character image data item that corresponds to the skill level of the player (SM11), and outputs this signal to the image control circuit 71 (SM12).

Based on the character image selecting signal outputted from the main CPU 42, the image control CPU 71a of the image control circuit 71 selects, from image data items stored in the image ROM 71d, a character image data item corresponding to the skill level of the player (SM13). A character image corresponding to the selected character image data item is, as shown in FIG. 11A, displayed at a lower-right of the main display 3 (SM14). A text image of “END” is displayed on a left side of the character image GA.

Similarly to the slot machine 1 described above, each part of the character image GA (e.g., a head GA1, a right arm GA2, a left arm GA3, etc.) displayed on the main display 3 is associated with one or more kinds of game related image data items or game related sound data items which belong to the same skill level and are stored in the image ROM 71d of the image control circuit 71 and in the sound ROM of the sound control circuit 72.

Similarly to the slot machine 1 described above, while a player is playing a game in the slot machine 1, the main CPU 42 updates a game history data item of the player as the game progresses and at the same time updates a data item about the current time.

Executed in the game system 100 is a game related information providing processing which is the same as the game related information providing processing executed in the slot machine 1, and therefore a description thereof will be omitted here.

Next, a game history information update processing executed in the game system 100 will be described with reference to FIG. 16.

First, when a player touches a part indicating “END” on the main display 3 shown in FIG. 11A in order to end a game in the slot machine 1, the touch panel 3a outputs a game end signal to the main CPU 42 (SN15). After the game end signal is outputted to the main CPU 42, the main CPU 42 stops updating a game history data item (SM16). The updated game history data item is, together with the ID number of the FIG. 165 which is temporarily stored in the RAM 44, transmitted from the communication processor 23 to the server 21 (SM17).

The server communication processor 21f receives the game history data item and the ID number of the FIG. 165 transmitted from the slot machine 101 (SS5), based on which the game history data item stored in the server memory 21d is updated (SS6).

As thus far described above, in the game system 100 of this embodiment, a character image data item corresponding to a skill level of a player is, based on an ID number stored in the wireless tag of the FIG. 165 of the player, selected via communication between the slot machine 101 and the server 21, and a character image GA corresponding to the selected character image data item is displayed on the main display 3. Thus, similarly to the slot machine 1 described above, game related information such as a character image GA suitable for each player, i.e., suitable for a skill level of each player can easily and surely be provided.

If each slot machine 101 controls a game history data item of a player, a player cannot get game related information corresponding to his/her latest game history data item unless he/she always plays a game in the same fixed slot machine. In the game system 100 of this embodiment, however, the server 21 controls game history data items of multiple players in a mass. Therefore, no matter which one of the slot machines 101 connected to the server 21 is used by a player for playing a game, the player can get game related information corresponding to his/her latest game history data item. More specifically, the server memory 21d stores a game history data item of each player which is associated with an ID number of his/her FIG. 165. Therefore, no matter which one of the many slot machines 101 placed in the game shops A and B is used by a player for playing a game, the player can surely get game related information corresponding to his/her skill level.

In the game system 100, a game history data item of a player updated as a game progresses in the slot machine 101 is transmitted from the slot machine 101 to the server 21, so that a game history data item stored in the server memory 21d is updated. Therefore, the player can get game related information corresponding to his/her skill level based on his/her latest game history data item.

In the above-described embodiment, the slot machine 1, 101 is applied as a gaming machine, but this is not limitative. For example, a card game machine, a Japanese card game machine, a mahjong game machine, and the like may be applied.

In the slot machine 1, 101, game related information is provided via the main display 3, the sub display 4, and the speakers 11L and 11R, but it may not always be provided via these media. For example, any one of the main display 3 and the sub display 4 may be omitted. In case of omitting the sub display 4, the main display 3 may display game related information, for example, in such a manner that a screen showing the character image GA as in FIG. 11A may be switched into a screen as in FIG. 11B or 11C, or in such a manner that the screen of FIG. 11A may be displayed concurrently with the screen of FIG. 11B or 11C.

In the slot machine 1, a skill level of a player is judged based on his/her game history data item stored in the memory of the wireless tag of the FIG. 65. However, it is also possible that the memory of the wireless tag of the FIG. 65 stores an ID number of this FIG. 65 based on which a skill level of a player is judged. In this case, for example, ID numbers are classified into beginner numbers, intermediate numbers, and advanced numbers.

The slot machine 1 employs the reading/writing unit 6 having the wireless tag reader/writer 62. However, the reading/writing unit may be replaced with a reading unit having a wireless tag which can read out a data item from the memory of the wireless tag but cannot write a data item into the memory of the wireless tag. For example, a reading unit having a wireless tag reader can be employed in order to judge a skill level of a player based on an ID number of the FIG. 65 as described above.

In the slot machine 1, 101, the wireless tag reader/writer 62 or the wireless tag reader is provided and reads out a data item stored in the FIG. 65, 165 by means of wireless communication. However, a data item may be read out by means of wire communication or infrared communication. In this case, for example, a connection port such as a USB port and an IR port is provided in order to connect the reading/writing unit 6 or the reading unit 106 of the slot machine 1, 101 to the FIG. 65, 165.

In the slot machine 1, 101, a player can play a slot game irrespective of whether the FIG. 65, 165 is held on the machine. However, it is also possible to keep a player from playing a slot game unless the FIG. 65, 165 is held. That is, only players having FIGS. 65, 165, or in addition players having no FIG. 65, 165 may be allowed to play on the machine.

In the slot machine 1 and the game system 100, data items including image data items and sound data items about game related information which is additionally provided to a player are stored in the main CPU 42, the RAM 43, the ROM 44, the image control circuit 71, the sound control circuit 72, etc., of the slot machine 1, 101. However, an additional circuit may be provided to store the data items.

The character image GA displayed on the main display 3 of the slot machine 1, 101 may be changed in association with update of the game history data item of a player. For example, if a player is judged to be the beginner when starting a game in the slot machine 1, 101, a character image GA corresponding to the beginner is displayed. Then, when his/her game history data item is updated as the game progresses, e.g., when the total number of games played becomes 201 or more, a character image corresponding to the intermediate may be displayed instead.

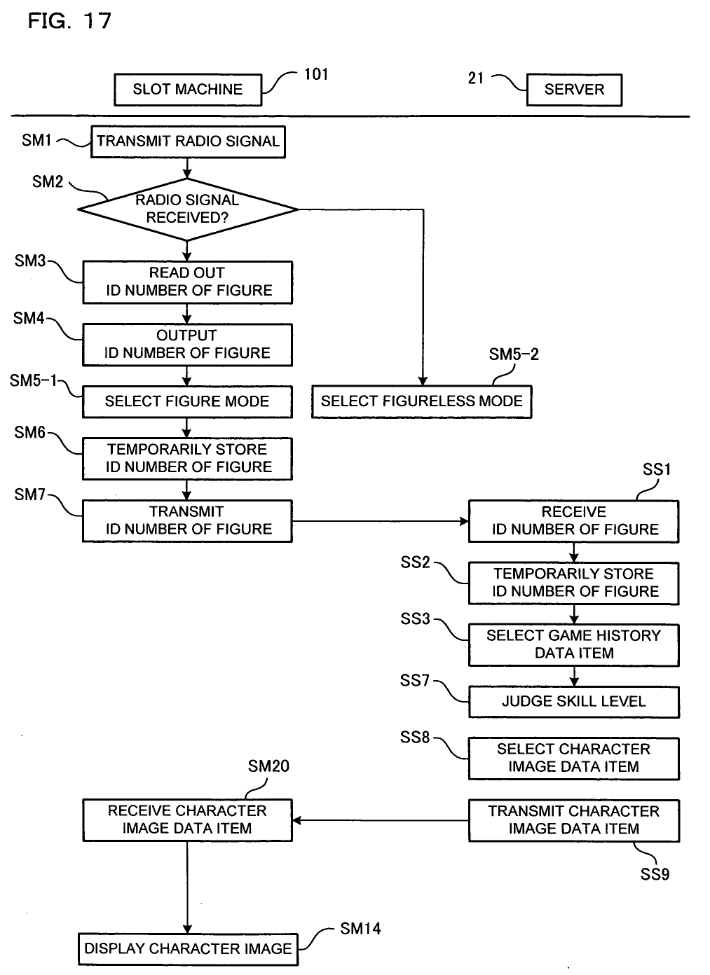

In a modification of the game system 100, the server memory 21d may further store game related data items such as image and sound data items, while the slot machine 101 may not store the game related data items. FIG. 17 shows a flowchart of a character image display processing which is executed in a game system of this modification. Here, after the steps SM1 to SM7 and SS1 to SS3 same as in FIG. 15 are performed, the server 21 judges, at SS7, the player's skill level based on the game history data item selected at SS3. Then, the server 21 selects, from data items stored in the server memory 21d, a character image data item corresponding to the player's skill level (SS8), and transmits the character image data item to the gaming machine 101 (SS9). The gaming machine 101 receives the character image data item from the server 21 (SM20), and displays a character image corresponding to the character image data item (SM14).

In this modification, the server 21 can control game related information which is provided to players playing on any slot machines 101. Therefore, no matter which one of the slot machines 101 connected to the server 21 is used by a player, the player can get game related information including his/her latest game history data item, information about comparison between game histories of players, e.g., a ranking of the number of coins obtained, and the like.

In this modification the server 21 may select a game related data item based on, instead of the game history data item as described above, a touch detection signal outputted from the touch panel 3a of the slot machine 101 to the server 21. The game related data item thus selected is transmitted to the slot machine 101 which then provides a player with game related information corresponding to the game related data item.

The game related information is not limited as long as it may be transmitted to a player, visually, audially, or the like.

A recording medium is not limited to the FIG. 65, 165, but may be a member's card of a game arcade, a room key of a hotel, or the like.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A gaming machine comprising:
a storage unit that stores a plurality of game related data items;
a reading unit that reads out, from a recording medium held by a player, first selection information for selecting a first game related data item from the plurality of game related data items;
a first selecting unit that selects, based on the first selection information read out by the reading unit, the first game related data item from the plurality of game related data items stored in the storage unit; and
a first providing unit that provides the player with game related information corresponding to the first game related data item selected by the first selection unit.

2. The gaming machine according to claim 1, wherein the storage unit stores second to n-th (n: an integer equal to or greater than 2) game related data items each associated with the first game related data item, and wherein the gaming machine further comprises:
an input unit through which the player inputs second selection information for selecting a k-th (k: any integer of 2 to n) game related data item from the second to n-th game related data items;
a second selecting unit that selects, based on the second selection information inputted through the input unit, the k-th game related data item from the second to n-th game related data items stored in the storage unit; and
a second providing unit that provides the player with game related information corresponding to the k-th game related data item selected by the second selection unit.

3. The gaming machine according to claim 2, wherein:
the first game related data item is an image data item;
the first providing unit has a display device that displays an image corresponding to the image data item;
the image displayed on the display device has a plurality of parts each associated with one or more of the second to n-th game related data items;
the input unit includes a detector that detects, among the plurality of parts of the image, a part touched by the player;
the second selection information is information about the part detected by the detector; and
the k-th game related data item selected by the second selecting unit is a data item associated with the part detected by the detector.

4. The gaming machine according to claim 3, wherein the first game related data item is a character image data item.

5. The gaming machine according to any one of claims 1 to 4, wherein the recording medium records, as the first selection information, a game history data item of the player, and wherein the gaming machine further comprises:
an updating unit that updates the game history data item read out from the recording medium by the reading unit; and
a writing unit that writes into the recording medium the game history data item updated by the updating unit.

6. A game system comprising one or more gaming machines and a server connected in communication with the gaming machines,
wherein each of the gaming machines comprises:
a game related data item storage unit that stores a plurality of game related data items;
a reading unit that reads out, from a recording medium held by a player, identification information of the player;
an identification information transmitting unit that transmits to the server the identification information read out by the reading unit;
a game history data item receiving unit that receives a game history data item of the player transmitted from the server;
a game related data item selecting unit that selects, based on the game history data item received by the game history data item receiving unit, one or more from the plurality of game related data items stored in the game related data item storage unit; and
a providing unit that provides the player with game related information corresponding to the game related data item selected by the game related data item selecting unit, and
wherein the server comprises:
a game history data item storage unit that stores game history data items of a plurality of players;
an identification information receiving unit that receives the identification information transmitted from any one of the gaming machines;
a game history data item selecting unit that selects, based on the identification information received by the identification information receiving unit, one from the game history data items of the plurality of players stored in the game history data item storage unit; and
a game history data item transmitting unit that transmits to the one of the gaming machines the game history data item selected by the game history data item selecting unit.

7. A game system comprising one or more gaming machines and a server connected in communication with the gaming machines,
wherein each of the gaming machines comprises:
a reading unit that reads out, from a recording medium held by a player, identification information of the player;
an identification information transmitting unit that transmits to the server the identification information read out by the reading unit;
a game related data item receiving unit that receives a game related data item transmitted from the server;
a providing unit that provides the player with game related information corresponding to the game related data item received by the game related data item receiving unit, and
wherein the server comprises:
a storage unit that stores a plurality of game related data items and game history data items of a plurality of players;
an identification information receiving unit that receives the identification information transmitted from any one of the gaming machines;
a game history data item selecting unit that selects, based on the identification information received by the identification information receiving unit, one from the game history data items stored in the storage unit;
a game related data item selecting unit that, based on the game history data item selected by the game history data item selecting unit, selects one or more from the game related data items stored in the storage unit; and
a game related data item transmitting unit that transmits to the one of the gaming machines the game related data item selected by the game related data item selecting unit.
